(19) United States
(12) Patent Application Publication
(10) Pub. No.: US 2024/0185714 A1
(43) Pub. Date: Jun. 6, 2024

(54) SYSTEMS, DEVICES, AND METHODS FOR ADAPTING TRAFFIC TO PRIORITIZED VEHICLE ROUTES

(71) Applicant: INTEL CORPORATION, Santa Clara, CA (US)

(72) Inventors: Satish JHA, Portland, OR (US); Kathiravetpillai SIVANESAN, Portland, OR (US); S M Iftekharul ALAM, Hillsboro, OR (US); Kuilin Clark CHEN, Portland, OR (US); Kshitij DOSHI, Tempe, AZ (US); Leonardo GOMES BALTAR, Munich (DE); Francesc GUIM BERNAT, Barcelona (ES); Arvind MERWADAY, Beaverton, OR (US); Markus Dominik MUECK, Unterhaching (DE); Suman A. SEHRA, Folsom, CA (US); Vesh Raj SHARMA BANJADE, Portland, OR (US); Soo Jin TAN, Shanghai (CN)

(21) Appl. No.: 18/556,367

(22) PCT Filed: Sep. 24, 2021
(86) PCT No.: PCT/CN2021/120322

§ 371 Date: Oct. 20, 2023

(51) Int. Cl. G08G 1/087; G01C 21/34; G08G 1/00; G08G 1/09

(52) U.S. Cl. CPC G08G 1/087; G01C 21/34; G08G 1/09; G08G 1/20

(57) ABSTRACT

The disclosure relates to systems, methods, and devices for managing traffic through a road segment and/or intersection. The traffic management system may place traffic objects in a collaboration group for coordinating movements in the road segment and/or intersection in response to a received indication that an emergency vehicle has a planned route that includes the road segment and/or intersection. The traffic management system may determine a movement plan for each traffic object in the collaboration group based on received measurements about the road segment and the planned route of the emergency vehicle. The traffic management system may control a transmitter to send the movement plan to each traffic object in the collaboration group.

### CROSS-REFERENCE TO RELATED APPLICATIONS

This is a US national phase of PCT Application PCT/CN2021/120322, filed on Sep. 24, 2021, the entire contents of which are incorporated herein by reference.

### TECHNICAL FIELD

The disclosure relates to traffic adaption at roads and intersections where a high priority vehicle, such as an emergency vehicle, may have a planned route.

### BACKGROUND

Today's vehicles typically include numerous sensing systems and communication systems that may be used to detect the environment around a vehicle and to communicate this information with and receive sensor information from a number of other traffic-related objects. For example, vehicle-to-everything (V2X) (also known as connected-vehicle-to-everything) communications allows vehicles to communicate with static and active objects that may be in the traffic environment. V2X communications are also known as intelligent transport systems (ITS) communications, and encompass communications among vehicles as well as between vehicles and other objects. For example, vehicle-to-vehicle (V2V) communications allow vehicles to communicate with one another, and vehicle-to-infrastructure (V2I) communications allow vehicles to communicate with street lights, buildings, etc., and in both cases, the shared information may be used to understand, predict, and react to the constellation of objects in the traffic environment.

Despite the existence of such communication systems, priority vehicles such as emergency vehicles (EVs) (e.g., ambulances, police cars, fire engines, etc.) typically rely on separate preemption systems (e.g., Tramsmax, OPTICOM, GERTRUDE, FAST, EMTRAC, etc.) to indicate their priority status to infrastructure equipment at approaching intersections, where the infrastructure equipment may acknowledge the request and modify regular signal operation in order to provide a prioritized scheme for the approaching EV (e.g., a green phase of a traffic light in the direction of travel) until the EV has cleared the intersection. However, such preemption techniques are inefficient and often depend on specialized infrastructure-based equipment with limited communications ability, through mediums such as localized radio, line of sight, acoustic sensors and/or global positioning sensors (GPS).

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary aspects of the disclosure are described with reference to the following drawings, in which:

FIG. 1 shows an exemplary traffic management system for the movement of priority vehicles through road segments and/or intersections;

FIG. 2 depicts an exemplary flow diagram of a traffic management system for managing the movement of priority vehicles through a road segment and/or intersection;

FIG. 3 shows a schematic flow diagram of a traffic management method for priority vehicles.

### DESCRIPTION

The following detailed description refers to the accompanying drawings that show, by way of illustration, exemplary details and features.

The word “exemplary” is used herein to mean “serving as an example, instance, or illustration”. Any aspect or design described herein as “exemplary” is not necessarily to be construed as preferred or advantageous over other aspects or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc., where “[ . . . ]” means that such a series may continue to any higher number). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc., where “[ . . . ]” means that such a series may continue to any higher number).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

A “vehicle” may be understood to include any type of driven object. By way of example, a vehicle may be a driven object with a combustion engine, a reaction engine, an electrically driven object, a hybrid driven object, or a combination thereof. A vehicle may be or may include an automobile, a bus, a mini bus, a van, a truck, a mobile home, a vehicle trailer, a motorcycle, a bicycle, a tricycle, a train locomotive, a train wagon, a moving robot, a personal transporter, a boat, a ship, a submersible, a submarine, a drone, an aircraft, or a rocket, among others. It should also be understood that the term emergency vehicle (EV) may be used interchangeably with “priority vehicle” and may be any type of driven object that has a higher priority than other vehicles/objects in a particular traffic constellation. Thus, an emergency vehicle may include not only ambulances, fire trucks, police vehicles, etc., but also any type of vehicle with a priority designation (e.g., a diplomatic vehicle or a vehicle in a funeral procession).

Any of the radio links described herein may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 5G, 5G New Radio (5G NR), 3GPP 5G New Radio, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Zigbee, Bluetooth®, Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V2I) and Infrastructure-to-Vehicle (I2V) communication technologies, 3GPP cellular V2X, DSRC (Dedicated Short Range Communications) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety related applications in the frequency range 5,875 GHz to 5,905 GHz), ITS-G5B (i.e., Operation in European ITS frequency bands dedicated to ITS non-safety applications in the frequency range 5,855 GHz to 5,875 GHz), ITS-G5C (i.e., Operation of ITS applications in the frequency range 5,470 GHz to 5,725 GHz)), DSRC in Japan in the 700 MHz band (including 715 MHz to 725 MHz), IEEE 802.11bd based systems, etc.

Aspects described herein can be used in the context of any spectrum management scheme including dedicated licensed spectrum, unlicensed spectrum, license exempt spectrum, (licensed) shared spectrum (such as LSA=Licensed Shared Access in 2.3-2.4 GHz, 3.4-3.6 GHz, 3.6-3.8 GHz and further frequencies and SAS=Spectrum Access System/CBRS=Citizen Broadband Radio System in 3.55-3.7 GHz and further frequencies). Applicable spectrum bands include IMT (International Mobile Telecommunications) spectrum as well as other types of spectrum/bands, such as bands with national allocation (including 450-470 MHz, 902-928 MHz (allocated, for example, in the US (FCC Part 15)), 863-868.6 MHz (allocated, for example, in the European Union (ETSI EN 300 220)), 915.9-929.7 MHz (allocated, for example, in Japan), 917-923.5 MHz (allocated, for example, in South Korea), 755-779 MHz and 779-787 MHz (allocated, for example, in China), 790-960 MHz, 1710-2025 MHz, 2110-2200 MHz, 2300-2400 MHz, 2.4-2.4835 GHz (e.g., ISM band with global availability, used by Wi-Fi 11b/g/n/ax and by Bluetooth), 2500-2690 MHz, 698-790 MHz, 610-790 MHz, 3400-3600 MHz, 3400-3800 MHz, 3800-4200 MHz, 3.55-3.7 GHz (allocated, for example, in the US for Citizen Broadband Radio Service), 5.15-5.25 GHz and 5.25-5.35 GHz and 5.47-5.725 GHz and 5.725-5.85 GHz bands (allocated, for example, in the US (FCC part 15), including four U-NII bands, for a total of 500 MHz of spectrum), 5.725-5.875 GHz (allocated, for example, in the EU (ETSI EN 301 893)), 5.47-5.65 GHz (allocated, for example, in South Korea, 5925-7125 MHz and 5925-6425 MHz band (under consideration in the US and the EU, respectively). Next generation Wi-Fi systems are expected to include operating bands the 6 GHz spectrum, IMT-advanced spectrum, IMT-2020 spectrum (expected to include 3600-3800 MHz, 3800-4200 MHz, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHz, 37-38.6 GHz, 38.6-40 GHz, 42-42.5 GHz, 57-64 GHz, 71-76 GHz, 81-86 GHz and 92-94 GHz, etc.), the ITS (Intelligent Transport Systems) band of 5.9 GHz (typically 5.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHz), 57-64/66 GHz (in the US FCC part 15 allocates a total of 14 GHz of spectrum, while the EU, ETSI EN 302 567 and ETSI EN 301 217-2 (for fixed P2P) allocates a total of 9 GHz of spectrum), the 70.2 GHz-71 GHz band, any band between 65.88 GHz and 71 GHz, bands currently allocated to automotive radar applications such as 76-81 GHz, and future bands including 94-300 GHz and above. Furthermore, the scheme can be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

The apparatuses and methods described herein may be implemented using a hierarchical architecture, e.g., by introducing a hierarchical prioritization of usage for different types of users (e.g., low/medium/high priority, etc.), based on a prioritized access to the spectrum (e.g. with highest priority given to tier-1 users, followed by tier-2, then tier-3, etc.).

The apparatuses and methods described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.].

Some of the features in this document are defined for the network side, such as Access Points, eNodeBs, New Radio (NR) or next generation Node Bs (gNodeB or gNB—note that this term is typically used in the context of 3GPP fifth generation (5G) communication systems), etc. Still, a User Equipment (UE) may take this role as well and act as an Access Points, eNodeBs, gNodeBs, etc. In other words, some or all features defined for network equipment may be implemented by a UE.

As noted above, existing traffic-related systems may not provide for efficient movement of priority vehicles through roads and intersections. As will be explained in more detail below, the disclosed system may provide efficient coordination among road users and traffic control devices to improve movement of priority vehicles (e.g., emergency vehicles or EVs) through roads, intersections, and at traffic control devices. For example, the disclosed system enables cooperation among connected vehicles (e.g., vehicles with V2X communication capabilities) so that the vehicles may adapt, as a cooperative group, their movement, their routing, the inter-vehicle spacing, and the use of a specific lane/road-segment in order to prioritize movement of the priority vehicle through the particular location. In addition, the system may also coordinate with traffic control devices so that the traffic control devices (e.g., an intersection traffic controller (ITC) (e.g. a traffic light)) adapt their signaling (e.g., issue an infrastructure command to change to a red light or green light) to assist the vehicles in group with their movements and to assist the emergency vehicle in efficiently transiting through the location. In addition, the system takes into account vulnerable road users (VRUs) (e.g., pedestrians, non-connected vehicles, under-connected vehicles, etc.) that may be slower, more vulnerable, are unable to send/receive V2X messages, or are able to send/receive only limited V2X messages. As a result, the disclosed cooperative and connected system provides a real-time and cost-effective prioritization system for emergency vehicles, with minimal disruption to other road users.

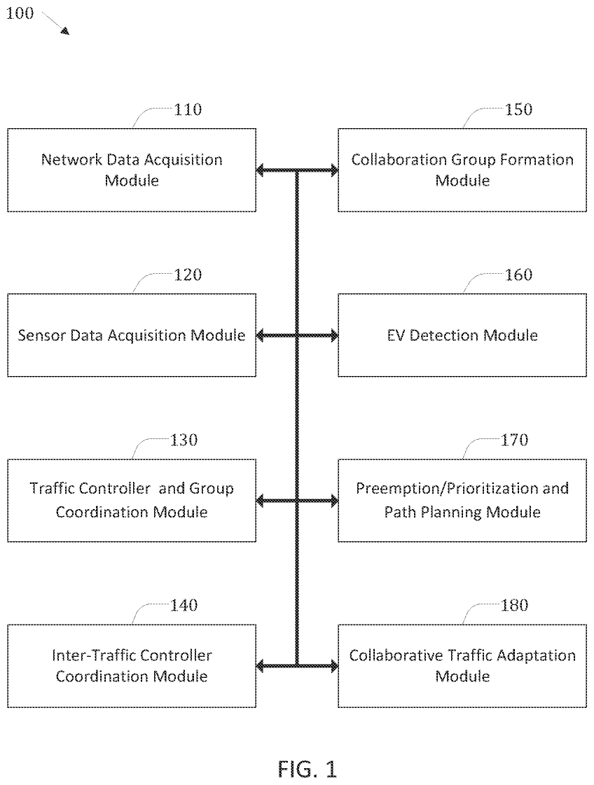

FIG. 1 shows exemplary traffic management system 100 that may employ various modules in communication with one another to provide a cooperating connected vehicle system for the movement of priority vehicles through road segments and intersections. Traffic management system 100 may include, for example, a network data acquisition module 110, a sensor data acquisition module 120, a traffic controller and group coordination module 130, an inter-traffic controller coordination module 140, collaboration-group formation module 150, EV detection module 160, a preemption/prioritization and path planning module 170, and/or a collaborative traffic adaptation module 180. While the features of these modules have been depicted in FIG. 1 and described below as separate modules for ease of description, it should be appreciated that the features provided in any such module may be implemented in any other module and need not necessarily be segregated in or be segregable into separate modules.

The network data acquisition module 110 may include, for example, communication hardware and/or software for facilitating the transmission, reception, and/or encoding/decoding of informational messages that may be sent among vehicles and traffic devices, including, for example V2X messages. Traffic objects, such as road side units (RSUs), traffic controllers, and/or vehicles (e.g., vehicles approaching toward, waiting at, or leaving from an intersection) may share messages with one another, including basic, safety, awareness, request (e.g., intersection cross request), and/or cooperation messages. In addition, messages received by one traffic object may forward the message on to other traffic objects, as is appropriate. For example, a vehicle may send an intersection cross request that may include information about the vehicle's current location, the number of other vehicles that are associated with the request, the length of the vehicle or group vehicles that are associated with the request, the expected time it may take for the vehicle or group of vehicles to cross intersection, etc. Information about the emergency vehicle (e.g., a vehicle with a priority) may also be exchanged among traffic objects (e.g., via V2X messages), including for example, information about the EV's current location, speed, type (e.g., an ambulance, a police car, a fire truck, a diplomatic vehicle, etc.), route, etc.

Even though the emergency vehicle may not be in range of a particular intersection, the information about the emergency vehicle may be forwarded to and/or shared with traffic objects in other intersections. For example, an emergency vehicle may periodically provide its information (e.g., using safety, awareness, cooperation, etc. V2X messages) with proximate traffic objects or the traffic objects may sense/discover information about a nearby emergency vehicles. Then, traffic objects that have learned about an EV may forward the learned information to relevant traffic objects that may be along the planned route of the emergency vehicle (e.g., to vehicles, RSUs, or traffic controllers that are located in an intersection or road segment along the path of the emergency vehicle). As discussed in more detail below, the information about the emergency vehicle may be transmitted in a series of multiple communications (e.g., “hops”) between multiple objects that may be within communication of other traffic objects along the planed route of the emergency vehicle.

In addition to data acquisition provided by the network data acquisition module 110, the traffic management system 100 may include a data acquisition module 120 that may include, for example, sensor hardware and/or software for sensing, detecting, and measuring information about the environment proximate the sensor. For example, sensors such as cameras, Light Detection and Ranging (LiDAR), radar, audio sensors, light sensors, positional sensors, magnetic sensors, gyroscopes, etc. may be used to collect data about the environment near the traffic object. For example, the data acquisition module 120 may use on-board sensors of a vehicle to detect the presence, path, speed, etc. of a nearby emergency vehicle. As another example, the data acquisition module 120 may use on-board sensors of a vehicle to detect the presence, path, speed, number, etc. of pedestrians or vehicles that are at, approaching, or leaving an intersection or road segment in the path of an emergency vehicle. As discussed above with respect to the network data acquisition module 110, traffic objects may collect this information so that it may be shared with other modules that may then process the information, use the information, and/or forward the information to other modules or other traffic objects.

The network data acquisition module 110 may also be able to deploy reconfigurable infrastructure units (e.g., drones or robots that have cameras or other infrastructure elements and can move to a specified location) in order to augment information about the traffic environment that may be experienced by the EV along its planned route. Any of the modules or traffic objects (including the EV itself) that may benefit from more detailed traffic environment data may request that the reconfigurable infrastructure provide more detailed information for a specific location/route in order to better plan the route for the EV, the maneuvers for the vehicles, etc. For example, assume that {V₁, . . . , Vₙ} are reconfigurable infrastructure units that are not fixed and that are movable within a certain range to monitor the area covered by the movable range. Each reconfigurable infrastructure unit may provide certain features that can generate information about the monitored area, given by {VᵢF₁, . . . , VᵢFₘ}. The availability of a given feature may depend on the type or identity of the requestor of the information (e.g., whether it is a group leader or an EV, whether the type of EV is a police vehicle or a diplomatic vehicle, etc.). An example of an available feature of each reconfigurable infrastructure unit is video monitoring/processing that may identify how crowded a particular area is in terms of VRUs (e.g., pedestrians) and/or the density of the vehicle traffic. If an EV has a route that involves a location serviced by an reconfigurable infrastructure unit, the traffic object (e.g., the group leader, the EV, etc.) may request information about the various reconfigurable infrastructure units that are available in the area and what features each reconfigurable infrastructure unit may provide (e.g. a specific type of video analytics, ability to calculate the volumetric representation of the road, ability to model detected inference, etc.). Based on the available set of features, the traffic object (e.g., the group leader, the EV, etc.) may request that the reconfigurable infrastructure unit(s) perform a selected set of features at a particular location for a particular period of time. Of course, the request may be for performance of a certain feature based on the current route (including timings) of the EV. After the reconfigurable infrastructure unit(s) perform the requested features (e.g., for the requested period of time), the reconfigurable infrastructure unit may return to the pool of available reconfigurable infrastructure units.

In addition, the availability of the reconfigurable infrastructure unit may depend on the priority of the traffic object requesting access to the features provided by the reconfigurable infrastructure unit. For example, an EV may have a higher priority than a group leader to request resources, or a group leader that is closer to the EV may have a higher priority than a group leader that is farther away from the EV. The reconfigurable infrastructure unit may provide its resources to the requesting traffic object with the highest priority, or negotiations between requesting traffic objects may take place to coordinate/distribute simultaneously-requested features (e.g., determine an appropriate division of time/area that is then provided to each requesting traffic object). In addition, if the competing requests for features are similar (e.g., requests are for similar features over a similar area of interest), the reconfigurable infrastructure unit may adapt its gathering of information in way that maximizes the ability to respond to both requests while still meeting the service requirements associated with each request.

Traffic management system 100 may also include a collaboration group formation module 150 that includes hardware and/or software for placing traffic objects into a coordination/collaboration group that may react collectively to the presence of an EV. A coordination group (or collaboration group) is a grouping of multiple traffic objects that may act in a coordinated way. This coordination may be designed, for example, to coordinate the movement of vehicles out of an intersection to clear a safe path for an approaching emergency vehicle or may coordinate the movement of vehicles out of a particular lane along a road segment in order to provide an open lane for expedited movement of an emergency vehicle through the road segment. As another example, the coordination group may include traffic control objects that coordinate traffic light changes so as to issue infrastructure commands that provide a green light to the emergency vehicle and/or that provide a green light to a group of vehicles that are coordinating their movements to pass through the intersection.

The collaboration group formation module 150 may add and/or remove traffic objects to/from the group based on information collected/received about the emergency vehicle (e.g., location, path, speed, etc.) and/or about other traffic objects that may be relevant to the emergency vehicle (e.g., vehicles and traffic control devices in road segments along the planned route of the emergency vehicle). The collaboration group formation module 150 may also elect/identify a leader of the group (e.g., a group leader) from among the members of the group. The collaboration group formation module 150 may change the leader of the group or merge with other groups as the situation changes. For example, as the emergency vehicle moves along its route, certain traffic objects may become relevant to the group or be in a better position to lead the group. Or, the group leader may be changed in response to membership changes in the group, where other group members may have better processing capability (e.g., message processing), better sensing capabilities, longer range communication capabilities, multiple types of communication technologies (e.g., supporting multiple forms of radio access technologies for wireless communications and/or supporting multi-protocols for communications), etc. A group leader may be responsible for determining membership in the group, coordinating with traffic controllers, determining movement information for the members of the group, transmitting messages, and/or providing instructions to other members of the group, other traffic objects, and/or the emergency vehicle.

The collaboration group formation module 150 may form the group for a limited time period. For example, the group may be formed to accomplish a particular task that may be related to the safe passage of the emergency vehicle. For example, a group may be formed for the purpose of allowing the emergency vehicle to cross through an intersection. Then, after the emergency vehicle has passed through the intersection, the group may be disbanded. Of course, the group may also remain for a time period after the emergency vehicle has passed through the intersection.

The collaboration group formation module 150 may determine membership in the group based on any number of criteria, including whether the traffic object is at a predefined distance from other members of the group, the emergency vehicle, and/or a particular intersection or road segment along the route of the emergency vehicle. Membership in the group may also depend on, for a moving traffic object, the direction of travel of the traffic object in relation to the planned route of the emergency vehicle. In addition, the emergency vehicle itself may be a member and/or leader of the group. In some cases, groups may be subdivided into smaller subgroups. For example, if a group receives an early notification that an emergency vehicle is approaching in a particular direction and along a particular route, the group may be subdivided into smaller groups according to the direction of travel of members of the group in relation to the direction of travel of the emergency vehicle. This may be done, for example, in coordination with the traffic controller, so that a smaller group of vehicles may transit an intersection using a shorter duration for the green phase for traffic along the subgroup's direction. This is because a green phase timing for the traffic control device may be calculated to allow an entire group to cross the intersection within the same phase timing (e.g., as a single entity in a single green cycle). If the green phase length needs to be adjusted, the group may need to be divided into subgroups of appropriate sizes so that the size of the group matches the phase timing.

Traffic management system 100 may also include an emergency vehicle (EV) detection module 160. The EV detection module 160 may include hardware and/or software for detecting the presence of an emergency vehicle based on any number of sources of information, including, for example, information obtained by the network data acquisition module 110 and/or the sensor data acquisition module 120 discussed above (e.g., sensor data and/or V2X messages). The detection may be based on a message that originated at the EV (and which may have been forwarded by other traffic objects). As one example, the EV detection module may obtain sound data and apply a sound recognition algorithm to identify the specific acoustic horn pattern associated with a known type of emergency vehicles by, for example, matching the received sound data and matching it to an expected sound pattern of a known emergency vehicle. Such an algorithm may include a spectral analysis (e.g., a Fourier transform (e.g. a Fast Fourier Transform) after sampling of the incoming sound signal) and then compare the spectral components (e.g., the outputs of the Fourier Transform) to the expected spectral components of the known emergency vehicle. If the difference (e.g., measured by a mean-square error calculation) is below a threshold, then the presence of an emergency vehicle may be confirmed.

As another example, the EV detection module may obtain camera information and apply a visual detection algorithm for visual characteristics (e.g., alternating red and/or blue light changes) that match an expected pattern of light changes associated with a known type of emergency vehicle. Such an algorithm may include a combination of a spectral analysis (e.g., detecting the specific alternating red and/or blue light changes for a known emergency vehicles, for example, by evaluating a video or single-frame image, identifying the color by comparing to reference colors associated with known emergency vehicles) and a cyclic repetition pattern analysis that may reveal the appropriate period of changes associated with the changing colors revealed by the spectral analysis that is indicative of the expected timing associated with the known emergency vehicle lighting. If the cyclic repetition pattern has a threshold level of correspondence to the reference pattern for the known emergency vehicle, then the presence of an emergency vehicle is confirmed.

Traffic management system 100 may also include a traffic controller and group coordination module 130 and/or an inter-traffic controller coordination module 140. The traffic controller and group coordination module 130 and inter-traffic controller coordination module 140 may include hardware and/or software for facilitating coordination among groups (e.g., via the group leader) to other traffic control objects that may be along the planned route of the EV (e.g., in the next consecutive geographic location at a time before the EV arrive in that geographic location). For example, the group leader at one location along the EV's route may coordinate with another group leader at a second location along the EV's route to coordinate movements. In this manner, the groups may adapt to and expedite the EV movements based on the instantaneous and dynamic situations of multiple groups over multi-hops. Given that the EV route may change dynamically (e.g., a law enforcement vehicle may need to change routes to follow an erratic target), the group coordination module 130 and/or an inter-traffic controller coordination module 140 provide for dynamic adaption across multiple groups. As EV leaves a first geographic location and moves to a second geographic location, the coordinating groups may restore normal traffic flow to the first geographic location so as to minimize the impact to the normal traffic flow. In addition, the group leaders of coordinating groups may use instructions/suggestions from other group leaders of the coordinating groups to update/provide instructions/suggestions to the EV with respect to its next location, including, for example, a recommended lane, a recommended acceleration, stopping instructions, and/or a recommended speed for approaching the next group's intersection, etc.

Traffic management system 100 may also include a preemption/prioritization and path planning module 170 that may include hardware and/or software for planning a prioritized path for the EV through a given road segment or at a particular intersection. Of course, when traffic is deadlocked, this may present a challenging scenario for path planning. In this case, the path planning module 170 may need to develop a path over a larger area (e.g., over multiple road segments and/or intersections) to reduce deadline and provide fast passage for the one or more EVs, and it may depend on the number of multiple groups that may be coordinating with one another or with other traffic controllers (as discussed above with respect to the traffic controller and group coordination module 130 and the inter-traffic controller coordination module 140). The preemption/prioritization and path planning module 170 may determine an optimized passage/path and driving recommendations (speed, acceleration, deceleration, stop instructions, lane recommendations, etc.) for the EV at various road segments and intersections. The preemption/prioritization and path planning module 170 may also access and utilize current traffic info (e.g., from cloud-based servers or from infrastructure message) and may use forecasting so that the recommend path for an EV may be adapted to avoid deadlocked areas. The preemption/prioritization and path planning module 170 recommend that vehicles be asked to change their route plan or take alternate routes (e.g., take the nearest exit, etc.) to reduce traffic congestion on the deadlock area and expedite movement of the EV at a particular location. Of course, in some cases, prioritizing EV movement may come at increased cost to other vehicles (e.g., decreased speed, increased wait time at an intersection, underutilization of an open lane, longer wait times for pedestrians or VRUs at an intersection or pedestrian crossing, unequal treatment of vehicles or pedestrians/VRUs located in a specific lane or heading in a specific direction, etc.).

In case of prioritizing multiple prioritized vehicles (e.g., two EVs) approaching a road segment or intersection at the same time, one EV may be prioritized over another EV based on factors such as type of prioritized vehicle, level of urgency of a given EV's current objective/task, etc. If more than one prioritized vehicle has the same level of priority, preemption/prioritization and path planning module 170 may randomly select one EV to be prioritized over the other. The preemption/prioritization and path planning module 170 may reserve a minimum amount of traffic signal phase that is sufficient to let one EV pass through the intersection and then traffic signal may be reserved for the next EV. Of course, if an EV is a member of a group that is crossing the intersection, the group may be divided into two subgroups, as discussed above, so that the higher priority EV may be assigned to the first group that crosses the intersection.

Traffic management system 100 may also include a collaborative traffic adaptation module 180 that includes hardware and/or software for determining traffic control device timings (e.g., traffic light phase timings) and adapting the movement of vehicles that are within a collaboration group. For example, in the case of an intersection, once an intersection traffic control device knows that an EV may be within a pre-defined range from intersection, the collaborative traffic adaptation module 180 may adapt traffic signal phase timings at the intersection to facilitate the prioritization scheme from the preemption/prioritization and path planning module 170 to expedite the movement of the EV through the road segment or intersection. For example, a traffic object (e.g., a traffic control device, road side unit, or vehicle) may learn that one or more EVs are planning to cross a given intersection. The traffic object may also learn whether the EV is acting as individual unit or whether it is a member of a coordination group in order to calculate the estimated phase timing required for the EV (and/or its group) to cross the intersection. The collaborative traffic adaptation module 180 may send updated speed, acceleration, stopping instructions, remaining traffic signal phase timing, etc. to the EV (and/or its group members and/or its group leader). Once the EV crosses the intersection, the collaborative traffic adaptation module 180 informs other traffic objects (e.g., via an acknowledgement message) that the EV has crossed the intersection so that normal traffic conditions may be resumed and/or movement coordination groups may be disbanded. The collaborative traffic adaptation module 180 may repeat such an acknowledgement message a pre-defined number of times. Infrastructure sensors, other road users, or any other traffic object may also send/forward the acknowledgement confirmation to other traffic objects that the EV has successfully crossed the intersection. The traffic objects may then resume normal operation.

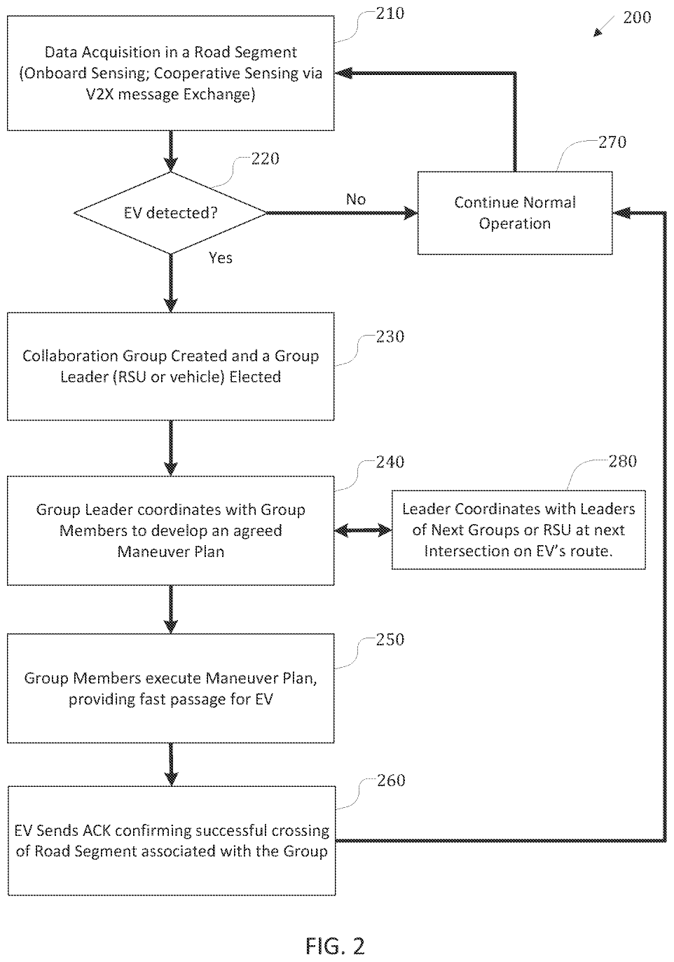

As noted explicitly and implicitly throughout the discussion above, the traffic management system 100 may apply to managing intersections (e.g., an intersection with or without an intersection traffic control unit or roadside unit) as well as to managing road segments (e.g., a road segment with or without a traffic control unit or roadside unit (e.g., roads between intersections)). FIG. 2 shows a flow diagram with various steps, 210, 220, 230, 240, 250, 260, 270, and 280, that a traffic management system (e.g., traffic management system 200) may follow for managing the movement of priority vehicles through a road segment and/or intersection, including one without a traffic control unit. In should be appreciated that traffic management system 200 may include any of the features/modules discussed above with respect to traffic management system 100.

For example, in step 210, the traffic management system 200 may gather and collect data from onboard sensing (e.g., at a traffic object along the road segment) and/or via message exchanges (e.g., V2X messaging) about the road segment and whether any EVs have a planned route through the road segment. In step 220, the traffic management system 200 may determine whether an EV is detected or identified in a certain proximity (e.g., within a certain distance) from a particular road segment. If no EV is detected, normal operation may continue, in step 270, and the system may continue, in step 210, to acquire data and exchange messages about the current road segment.

If an EV is detected, the first traffic object (e.g., a vehicle in the road segment or a road side unit of the road segment) to detect that the EV is destined for the road segment (e.g., located in a road segment ahead of and along the planned route of the EV) may create, in step 230, a collaboration group (e.g., a short-lived cooperative group) to assist in expediting the EV's eventual movement through the road segment. If the first traffic object to detect the EV is a vehicle, the vehicle may elect itself as group leader, and if an RSU is present in the proximity (or if other traffic objects are in the same vicinity), the group leader may transfer leadership to the RSU (or to any other traffic object, based on, for example, processing capability, sensing capability, communication ability with respect to neighboring groups or group leaders, ability to support multiple radio access technologies and/or protocols, etc.). As noted above with respect to FIG. 1, the EV may be detected by an EV detection module 160 using information obtained by the network data acquisition module 110 and/or the sensor data acquisition module 120 discussed above (e.g., sensor data and/or V2X messages). The group leader may also identify other traffic objects that should be joined as members to the group. For example, vehicles located within communication range of the leader and located ahead of the EV in the direction of EV's direction/planned route. The group leader may send requests to join the group by sending, for example, a V2X message (e.g., a Maneuver Coordination Message MCM, or a newly defined message). The group leader may also request that vehicles traveling in or located in opposite-direction lanes also join the group.

Next, in step 240, the group leader may coordinate with the EV and traffic objects that are members of the group to propose and negotiate group maneuvers that will provide safe, fast passage to the EV through the given road segment. Such group maneuver plans may specify multiple coordinated actions/tasks for individual or multiple vehicles that are members of the group. For example, these coordinated tasks may be lane changes, deacceleration instructions, acceleration instructions, stopping instructions, traffic light phase changes, etc. that may assist other vehicles to merge into a given lane, provide an open path for the EV, etc. The maneuver's may be planned for performance in parallel, while other maneuver's may be planned to be carried out in sequence. To develop the planned maneuvers, the leader may analyze the situation (e.g., based on information it has acquired from on-board sensors or received from V2X messages) and prepare one or more alternative set of coordinated tasks for the group within a given time frame. Next, the group leader may share the proposed maneuver plans with the members of the group and negotiate any requested adjustments in order to arrive at a final, agreed group maneuver plan that may then be shared with the group.

It should be understood that the maneuver plans may consider traffic objects that may not be a member of the group (e.g., a non-connected vehicle, a pedestrian, etc.) and may not necessarily be able to coordinate its movements with the group maneuver. So, while some non-member traffic objects may be informed about planned maneuvers (e.g., through audible announcements, displayed warnings, or even through V2X messages (e.g., VRUs may be informed by vehicle-VAM (VAM—VRU awareness Message) or infrastructure-VAM messages), the leader does not assume that non-member traffic objects will necessarily heed and/or cooperate with the warning messages and the planned maneuvers.

In addition to negotiating and agreeing on a group maneuver plan associated with the leader's road segment, the leader may coordinate, in step 270, with leaders of other road segments/intersections that may also be along the planned route of the EV. This type of coordination may be helpful for further expediting the EV's movement by providing recommendations to the EV for an optimized passage through the current and future road segments/intersections that may include driving recommendations (speed, acceleration, deceleration, stop instructions, etc.) over multiple road segments/intersections. As part of this coordination, information may be provided back to the group leader from other road segments/intersections which may be used to build the group maneuver plan associated with the group leader's current road segment. In short, the leaders of each group associated with each of the multiple road segments/intersections, together with the EV, may share information and coordinate movement plans across the multiple road segments/intersections along the EV's path in order to continuously adapt and expedite movements based on the instantaneous/dynamic situation.

In step 250, the members of the group execute the agreed group maneuver plan, making any adjustments to the plan throughout the execution as necessary to account for the impact of non-member traffic objects.

Once the group maneuver plan is complete and the EV successfully transits the road segment associated with the maneuver group, in step 260, the EV may indicate (e.g., by sending a V2X message to the leader of the group) that the EV has transited the road segment, which may be repeated a pre-defined number of times. In addition, sensor data may be used to confirm that the EV has transited the road segment, and the group leader may verify that the EV has successfully transited the road segment based on the collective sensing available from members of the group or infrastructure in proximity to the road segment. Once the leader confirms successful transit of the EV through the road segment, the group may be disbanded and normal operation may continue, in step 270, and the system may continue, in step 210, to acquire data and exchange messages about the current road segment.

If packet needs to be forwarded to a destination in multi-hop for the selected communication path, a routing/forwarding with high reliability, lower latency and lower flooding (communication overhead) support can be used at higher layer (Network/Middleware). We propose communication-efficient multi-hop forwarding of EV's info towards leader/RSU/ITC. Proposed mechanisms broadcast EV's info beyond direct communication range (1-hop) by allowing direct communication range neighbors to relay/forward the EV's info towards leader/RSU/ITC on the route of EV. Selected Neighbors can include EV's info in the existing or in a new V2X message (at say Facility layer) for relaying/forwarding. It provides flexibility to leader/RSU/ITC to plan Expedited EV movement well ahead in time before EV arrives.

We propose a Geo-Area based routing for this purpose where a node knowing its Geo-area can determine next Geo-Area towards a given location (Geo-area of the destination of EV's Info). The existing Geo grid map systems (such as Military Grid Reference System MGRS, or Geo-Hash) can be used to divide the World into approximately square/rectangular Geo-areas of various granularities (such as 1 km by 1 km, 100 m by 100 m, 10 m by 10 m and so on) and each Geo-area can be represented by a string of digits and letters. Vehicle equipped with GPS sensors can determine its location and calculate its Geo-Area. Similarly, vehicle knowing destination location and road topology can determine consecutive Geo-areas of a given size to reach the Geo-area of the destination.

As noted earlier, information about the EV and its movements may be forwarded from one location (e.g., close to the EV) to other locations that are further along the EV's planned route. In particular, the information may be forwarded by the leader of one group to the leader of another group associated with the later road segment/intersection or to other traffic objects along the route. To avoid message flooding, only one or two nodes at a given location (e.g., a leader or other traffic object associated with a road segment/intersection) may be designated to forward EV-related messages to the next location. This may be accomplished, for example, using a forward-wait-timer managed in a distributed way at each node. In other words, each node that is forwarding messages may select a value for the forward-wait-timer based on parameters associated with the reachability of nodes at the next location. For example, a smaller forward-wait-timer value may be selected if the node is closer to the next location, has more neighbor nodes from the next location in its neighbor-list, has a better link quality/reliability with a node in the next location, etc. The first node at the location whose forward-wait-timer first expires may forward the EV-info message to the next location while other nodes suppress EV-info message forwarding once they hear that an EV-info message has been forwarded by the first forwarder. Message forwarding continues to further locations until EV-info messages have reached the destination location of the EV's current route. Of course, more than one node may forward EV-info messages to, for example, enhance reliability.

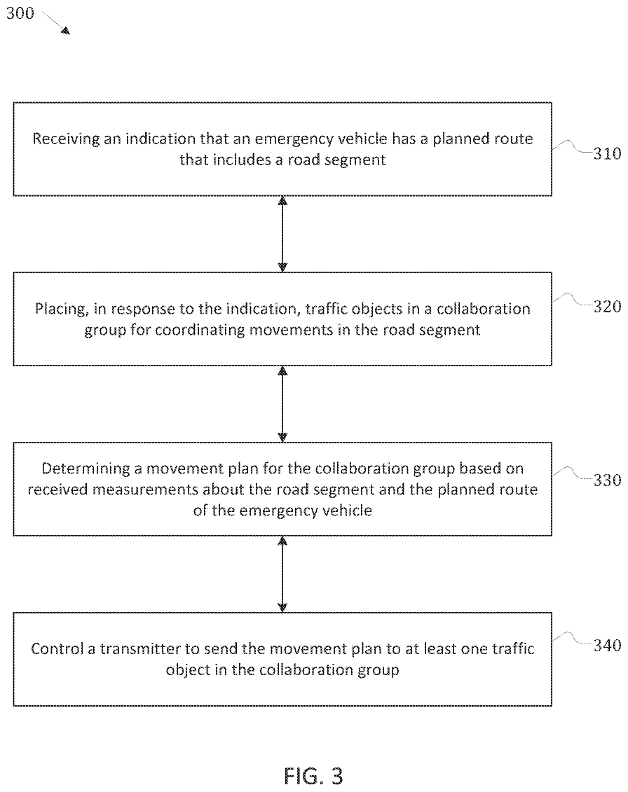

FIG. 3 depicts a schematic flow diagram of a method 300 for providing a traffic management system for priority vehicles. Method 300 may implement any of the features described above with respect to traffic management system 100 and/or 200.

Method 300 for managing traffic for priority vehicles includes, in 310, receiving an indication that an emergency vehicle has a planned route that includes a road segment. Method 300 also includes, in 320, placing traffic objects in a collaboration group for coordinating movements in the road segment in response to the indication. Method 300, in 330, also includes determining a movement plan for the collaboration group based on received measurements about the road segment and the planned route of the emergency vehicle. Method 300 also includes, in 340, controlling a transmitter to send the movement plan to at least one traffic object in the collaboration group.

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes, which come within the meaning and range of equivalency of the claims, are therefore intended to be embraced.

1. A traffic management apparatus comprising:
a processor configured to:
place traffic objects in a collaboration group for coordinating movements in a road segment in response to a received indication that an emergency vehicle has a planned route that includes the road segment; and
determine a movement plan for the collaboration group based on received measurements about the road segment and the planned route of the emergency vehicle; and
control a transmitter to send the movement plan to at least one traffic object in the collaboration group.

2. The traffic management apparatus of claim 1 further comprising a receiver configured to receive the received measurements and the received indication.

3. The traffic management apparatus of claim 2, wherein the receiver configured to receive the received indication comprises the receiver configured to receive a message with the received indication from the emergency vehicle.

4. The traffic management apparatus of claim 2, wherein the receiver configured to receive the received indication comprises the receiver configured to receive a message about the planned route of the emergency vehicle relayed from another traffic object in communication with the emergency vehicle.

5. The traffic management apparatus of claim 1 further comprising the transmitter configured to transmit the movement plan to each traffic object in the collaboration group.

6. The traffic management apparatus of claim 1, wherein the movement plan comprises at least one of a lane change, a velocity change, an acceleration change, and/or a route change for at least one traffic object in the collaboration group.

7. The traffic management apparatus of claim 5, wherein the transmitter is further configured to transmit the movement plan to an additional traffic object operating at an additional road segment that is along the planned route of the emergency vehicle, wherein the additional road segment is different from the road segment.

8. The traffic management apparatus of claim 1, wherein the traffic object comprises at least one of a vehicle, a traffic control unit, a roadside unit, and/or the emergency vehicle.

9. The traffic management apparatus of claim 1, wherein the road segment comprises at least one of a road, a portion of a road, an intersection, a portion of an intersection, and/or a plurality of roads and/or intersections.

10. The traffic management apparatus of claim 1, wherein the processor is further configured to generate a route recommendation for the emergency vehicle, wherein the route recommendation comprises a path through the road segment based on the received measurements and the movement information.

11. The traffic management apparatus of claim 1, wherein the processor is further configured to place an approaching traffic object in the collaboration group based on a geographic distance of the approaching traffic object from the road segment.

12. The traffic management apparatus of claim 1, wherein the processor is further configured to remove at least one of the traffic objects from the collaboration group based on an acknowledgement indicating that the emergency vehicle is not in the road segment or that the road segment is not along the planned route.

13. The traffic management apparatus of claim 4, wherein the movement information comprises an infrastructure command configured to indicate at least one of a traffic light color, a traffic light duration, a pedestrian crossing signal type, and/or a pedestrian crossing duration, and wherein the transmitter is further configured to transmit the infrastructure command to an infrastructure element in the road segment.

14. The traffic management apparatus of claim 1, wherein the received measurements about the road segment comprise sensor readings received from a reconfigurable infrastructure device.

15. The traffic management apparatus of claim 14, wherein the reconfigurable infrastructure device comprises a drone that has been instructed to provide the received measurements about the road segment.

16. The traffic management apparatus of claim 1, wherein the received indication comprises a plurality of received indications for a plurality of emergency vehicles, wherein the movement information is based on a priority associated with each emergency vehicle of the plurality of emergency vehicles.

17. The traffic management apparatus of claim 1, wherein the movement plan is further based on additional received measurements about an additional road segment along the planned route of the emergency vehicle, wherein the additional road segment is different from the road segment.

18. The traffic management apparatus of claim 1, wherein the processor is further configured to subdivide the traffic objects of the coordination group into a first subgroup and a second subgroup based on a transit time for the first subgroup to transit the road segment, wherein the phase timing associated with a traffic control device is based on the transit time.

19. An apparatus comprising:
a receiver configured to:
receive an indication that an emergency vehicle has a planned route that includes a road segment on which a vehicle is traveling; and
receive a request to join a collaboration group for coordinating movements in the road segment;
a processor configured to determine, based on the request and the indication, an acknowledgement indicating either an acceptance of the request to join the collaboration group or a denial of the request to join the collaboration group; and
a transmitter configured to transmit the acknowledgement,
wherein if the acknowledgement is the denial, the receiver is further configured to receive a movement plan of the collaboration group, wherein the movement plan comprises at least one of a lane change instruction, a deacceleration instruction, an acceleration instruction, a stopping instruction, and/or a traffic light phase changes instruction for the vehicle,
wherein the processor is further configured to control execution of the movement plan for the vehicle.

20. The apparatus of claim 19, wherein the transmitter is further configured to transmit the indication and/or the movement plan to a traffic object that is a member of the collaboration group and/or is along the planned route of the emergency vehicle.
